(19) United States
(12) Patent Application Publication
(10) Pub. No.: US 2015/0234226 A1
(43) Pub. Date: Aug. 20, 2015

(54) DISPLAY DEVICE AND TELEVISION RECEIVER DEVICE

(71) Applicant: Sharp Kabushiki Kaisha, Osaka-shi, Osaka (JP)

(72) Inventor: Jo Ikuta, Osaka (JP)

(73) Assignee: SHARP KABUSHIKI KAISHA, Osaka-shi, Osaka (JP)

(21) Appl. No.: 14/428,467

(22) PCT Filed: Sep. 12, 2013
(86) PCT No.: PCT/JP2013/074614

§ 371 Date: Mar. 16, 2015

(30) Foreign Application Priority Data
Sep. 19, 2012 (JP) 2012-205950

(51) Int. Cl. G02F 1/1333; H04N 5/655; H04N 5/645; G02F 1/1335

(52) U.S. Cl. CPC G02F 1/133308; G02F 1/1336; H04N 5/655; H04N 5/645; G02F 2001/13332; G02F 2001/133314

(57) ABSTRACT

A liquid crystal display device includes a backlight device; a liquid crystal panel; a chassis which is made of metal and further includes a chassis plate part, and chassis side-plates; a bezel which is made of metal and further includes a bezel frame-shaped part, and a bezel tube-shaped part; a front-side cabinet which configures an exterior appearance of the liquid crystal display device, is made of a resin, covers the bezel, and further includes an exterior frame shaped part, and an exterior tube-shaped part; positioning sections which are disposed in a form of protruding from the exterior frame-shaped part toward the chassis side, and which position the liquid crystal panel in a display face direction; and contact sections which are positioned in opposition to the positioning sections side with respect to each of the bezel tube-shaped part and the side-plates, and which make contact with both the side-plates and the exterior tube-shaped part.

### TECHNICAL FIELD

The present invention relates to a display device, and a television receiver device.

### BACKGROUND ART

For example, a liquid crystal display device such as a liquid crystal television requires a backlight device as a separate illumination device, because the liquid crystal panel, such as a display panel, does not emit light by itself. The backlight device in such kind of liquid crystal display device is classified as a direct-lit type or edge-light type depending on the mechanism, but it is preferable that the edge-light type backlight device be used to further realize a thin liquid crystal display device.

The display panel such as the aforementioned liquid crystal panel and the like is arranged on the display surface side of the backlight device in a configuration in which the edge is held by a frame-like member which forms a frame shape. In the backlight device provided with such a frame-like member, it is well known that the liquid crystal panel is positioned on the display surface direction by providing rib-shaped positioning sections, which face the side end surface of the display panel, in a part of the frame-like member. For example, Patent Document 1 discloses such a liquid crystal display device in which the rib-shaped positioning sections are provided on the frame-like member.

### RELATED ART DOCUMENT

### Patent Document

Patent Document 1: Japanese Patent Application Laid-Open Publication No. H11-337937

### SUMMARY OF THE INVENTION

### Problems to be Solved by the Invention

In the display device provided with the aforementioned frame-like member, there is a case in which the entire frame-like member contracts towards the center of the display panel due to the temperature drop after the entire frame-like member is thermally expanded by heat generated from the light source. In the liquid crystal display device disclosed in the aforementioned Patent Document 1, when the entire frame-like member contracts, there is a case in which stress is partially applied to the contact sections contacting with the positioning sections on the edge of the display panel by contacting the positioning sections with the side end surface of the liquid crystal panel arranged inside the frame-like member, and further contracting the frame-like member. With this, when the stress is partially applied to the edge of the display panel, this causes a phenomenon such as a part of the display surface of the display panel being displayed in white, and thus the display quality of the display surface is lowered.

The technology described in the present specification was accomplished in view of the above circumstances. An object of the present invention is to provide a technology to prevent or suppress the phenomenon in which a part of the display surface of the display panel is displayed in white.

### Means for Solving the Problems

The present specification discloses a display device that includes: an illumination device; a display panel that performs display with light from the illumination device; a chassis made of metal and arranged opposite to a display surface side of the display panel, the chassis including a plate that has a surface along the display surface of the display panel and a side-plate rising towards the display panel from an end of the plate of the chassis; a bezel made of metal and housing at least the illumination device and the display panel between the bezel and the chassis, the bezel including a bezel frame part that has a frame shaped surface along the display surface of the display panel and a bezel tube-shaped part cylindrically extending from edges of the bezel frame part of the bezel towards the chassis; an exterior member made of resin and forming an exterior of the display device, the exterior member covering at least the bezel and including an exterior frame part that has a frame shaped surface along the display surface of the display panel and an exterior tube-shaped part cylindrically extending from edges of the exterior frame part towards the chassis; a positioning section that protrudes from the exterior frame part toward the chassis, a portion of the positioning section facing an end face of the display panel, thereby positioning the display panel in a direction of the display surface; and a contact section provided on a side facing the bezel tube-shaped part and the side-plate of the chassis, the contact section being opposite to the positioning section and contacting the exterior tube-shaped part of the exterior member and at least one of the bezel tube-shaped part of the bezel and the side-plate of the chassis.

As described in the aforementioned display device, in the case in which the positioning sections positioning the display panel in the exterior frame shaped part of the exterior member are provided, when the high temperature state at the time of turning on the light source (in a state in which the exterior member is expanded by heat) shifts to the low temperature state at the time of turning off the light source, the exterior member entirely contracts in a direction of the center side of the display panel and the positioning sections contact with the side end surface of the display panel, and when the exterior member further contracts, the contacting part in the side end surface of the display panel is pressed in a direction of the center side of the display panel by positioning sections. In this point, in the aforementioned display device, when the exterior member contracts in a direction of the center side of the display panel, at the same time of the contraction of the exterior member, a pressing force is applied in a direction from the contact section to at least one of the bezel tube-shaped part and the side-plate contacting with the contact section, that is, in a direction of the contraction of the exterior member. The bezel tube-shaped part and the side-plate are made of metal, whereas the exterior member is made of a resin, and thus the contraction percentage of each of the bezel tube-shaped part and the side-plate is low compared with the exterior member when the expanded state at the time of the high temperature shifts to the low temperature state. Therefore, even when a pressing force is applied in a direction from the exterior tube-shaped part of the exterior member to at least one of the bezel tube-shaped part and the side-plate through the contact sections, the contact sections are reversely pressed from at least one of the bezel tube-shaped part and the side-plate contacting with the contact sections. As a result, the exterior tube-shaped part of the exterior member is pressed in the opposite direction from the direction of the contraction of the exterior member through the contact sections.

Here, the direction of the pressing force applied to at least one of the bezel tube-shaped part and the side-plate equals to the direction of the contraction of the exterior member, the contraction of the exterior member is prevented and suppressed by applying the pressing force to the exterior tube-shaped part in the direction which is opposite from the direction of the contraction of the exterior member. As a result, it prevents the positioning sections from contacting with the side end surface of the display panel, or even when the positioning sections contact with the side end surface of the display panel, the pressing force applying in a direction from the positioning sections of the exterior member to the side end surface side of the display panel is reduced. Therefore, in the aforementioned display device, the phenomenon such that a part of the display face of the display panel is displayed in white caused by applying the pressing force to the parts facing the positioning sections in the side end surface of the display panel in the direction of the center side of the display panel by the positioning sections can be prevented and suppressed.

The contact section may be separate from the exterior member.

With such a configuration, the contact sections can be shifted after completing the assembly of the display device, and the position of the contact sections can be adjusted.

The contact section may be made of a material that is harder than the exterior member.

In the case in which the contact section is a separate member from the exterior member, when the contact section is made of a material which is softer than the exterior member and the contact section contracts by the exterior tube-shaped part due to the contraction of the exterior member, the pressing force may be hardly applied in the direction from the exterior tube-shaped part to at least one of the bezel tube-shaped part and the side-plate through the contact section at the time of the contraction of the exterior member. In this point, according to the aforementioned configuration, the contact section hardly contracts by the exterior tube-shaped part at the time of the contraction of the exterior member, and thus the pressing force can be easily applied in the direction from the exterior tube-shaped part to at least one of the bezel tube-shaped part and the side-plate through the contact section at the time of the contraction of the exterior member. As a result, the contraction of the exterior member can be effectively prevented and suppressed.

The contact section may be part of the exterior member.

With such a configuration, the contact section can be integrally formed with the exterior member, and thus the assembly of the contact section can be simplified in the manufacturing processes of the display device, and the manufacturing processes can be shortened.

The contact section may be provided in a plurality.

With such a configuration, the contraction force of the exterior member in the direction of the center side of the display panel at the time of the contraction of the exterior member is effectively reduced by the plurality of contact sections. Therefore, at the time of the contraction of the exterior member, the pressing force applied to the parts of the side end surface of the display panel contacting with the positioning sections in a direction of the center side of the display panel by the positioning sections can be prevented and suppressed.

The contact section may have a frame shape along an inner periphery of the exterior tube-shaped part.

With such a configuration, the contact section entirely contacts with the outer periphery of at least one of the bezel tube-shaped part and the side-plate, and thus the contraction force of the exterior member in the direction of the center side of the display panel at the time of the contraction of the exterior member is effectively reduced by the contact section. Therefore, at the time of the contraction of the exterior member, the pressing force applied to the part of the display panel contacting with the positioning section in the direction of the center side of the display panel by the positioning section can be further prevented and suppressed.

the contact section overlaps the positioning section in a direction facing the positioning section from the end face of the display panel.

With such a configuration, the contact section and the positioning section are closely and adjacently formed, and thus at the time of the contraction of the exterior member, the pressing force applied to the part of the display panel contacting with the positioning section in the direction of the center side of the display panel by the positioning section can be effectively prevented and suppressed.

A portion of the contact section contacting one of the bezel tube-shaped part and the side-plate of the chassis may overlap the other of the bezel tube-shaped part and the side-plate of the chassis in a direction facing the positioning section from the end face of the display panel.

With such a configuration, the pressing force is applied to the contact section from both of the bezel tube-shaped part and the side-plate at the time of the contraction of the exterior member, and thus the contraction force of the exterior member in the direction of the center side of the display panel can be effectively prevented and suppressed.

The contact section may contact both the bezel tube-shaped part and the side-plate of the chassis

With such a configuration, the pressing force is applied to the contact section from both of the bezel tube-shaped part and the side-plate at the time of the contraction of the exterior member, and thus the contraction force of the exterior member in the direction of the center side of the display panel can be effectively prevented and suppressed.

The contact section may be in surface-to-surface contact with at least one of the bezel tube-shaped part and the side-plate of the chassis.

With such a configuration, the contact area of the part where the contact section contacts with at least one of the bezel tube-shaped part and the side-plate can be greater that the case in which the contact section is in point contact with at least one of the bezel tube-shaped part and the side-plate, and thus the pressing force is effectively applied to the contact section from at least one of the bezel tube-shaped part and the side-plate at the time of the contraction of the exterior member. Therefore, the contraction force of the exterior member in the direction of the center side of the display panel can be effectively prevented and suppressed.

The exterior member may include a first exterior member that has the exterior frame part and the exterior tube-shaped part and that covers the bezel from a side opposite to the display panel, and a second exterior member that has an exterior plate covering the plate of the chassis from the side opposite to the display panel and an exterior side-plate that rises towards the display panel from an outer end of the exterior plate, the exterior member covering the entire display device except for the display surface of the display panel.

With this, the detailed configuration of the display device in which the exterior member is defined as a cabinet can be realized.

In the technology described in the present specification, the display panel that includes a liquid crystal panel having liquid crystal as the display panel is novel and useful. Further, the television receiver provided with the aforementioned display device is novel and useful.

### Effects of the Invention

According to the technology disclosed in the present specification, the phenomenon such that a part of the display face of the display panel is displayed in white can be prevented and suppressed.

### BRIEF DESCRIPTION OF THE DRAWINGS

FIG. 1 is an exploded perspective view showing a schematic configuration of a television receiver device TV and a liquid crystal display unit LDU according to Embodiment 1;

FIG. 2 is a cross-sectional view showing a cross-sectional configuration taken along the long side direction of the liquid crystal display device 10;

FIG. 3 is a cross-sectional view of a main section in FIG. 2, and is a magnified cross-sectional view of a positioning section and a contact section on one side of the edges of the liquid crystal display device 10;

FIG. 4 is a plan view from a rear side of a front-side cabinet before the liquid crystal panel 11 is arranged;

FIG. 5 is a plan view from the rear side of the front-side cabinet after the liquid crystal panel 11 is arranged;

FIG. 6 is a cross-sectional view of a configuration taken along the long side direction of a liquid crystal display device 110 according to Embodiment 2;

FIG. 7 is a cross-sectional view of a main section in FIG. 7, and is a magnified cross-sectional view of a positioning section and a contact section on one side of the edges of the liquid crystal display device 110;

FIG. 8 is a plan view from a rear side of a front-side cabinet before a liquid crystal panel 111 is arranged;

FIG. 9 is a plan view from the rear side of the front-side cabinet before the liquid crystal panel 211 is arranged in the modification example of Embodiment 2;

FIG. 10 is a cross-sectional view of a configuration taken along the long side direction of a liquid crystal display device 310 according to Embodiment 3;

FIG. 11 is a cross-sectional view of a main section in FIG. 10, and is a magnified cross-sectional view of a positioning section and a contact section on one side of the edges of the liquid crystal display device 310; and

FIG. 12 is a plan view from the rear side of the front-side cabinet before the liquid crystal panel 311 is arranged.

### DETAILED DESCRIPTION OF EMBODIMENTS

### Embodiment 1

Embodiment 1 will be described in reference to the drawings. In the present embodiment, a liquid crystal display device (an example of a display device) 10 will be exemplified. An X-axis, a Y-axis and a Z-axis are described in a part of the drawings, and a direction of each axial direction corresponds to a direction described in each drawing. A Y-axis direction corresponds to a vertical direction, and an X-axis direction corresponds to a horizontal direction. Unless otherwise noted, a top to bottom direction will be explained based on a vertical direction, and in the cross-sectional drawings, the upper side of the drawing is defined as the front side and the lower side of the drawing is defined as the rear side.

The liquid crystal display device 10 and the television receiver device TV according to the present embodiment are provided with a liquid crystal display unit LDU, a pair of front and rear cabinets (an example of an exterior member) 32 and 34 that store the liquid crystal display unit LDU therebetween, a power source P, a tuner T, and a stand ST. The liquid crystal display unit LDU is provided with a liquid crystal panel 11 and a backlight device (an example of an illumination device) 12, which are stored inside the pair of cabinets 32 and 34 that are the exterior member configuring the exterior appearance of the liquid crystal display device 10. An exposed part of the pair of cabinets 32 and 34 in the front side of the liquid crystal display device 10 is defined as a front-side cabinet 32, and an exposed part of the pair of cabinets 32 and 34 in the rear side of the liquid crystal display device 10 is defined as the rear-side cabinet 34. The front-side cabinet 32 and the rear-side cabinet 34 configure the exterior appearance of the liquid crystal display device 10.

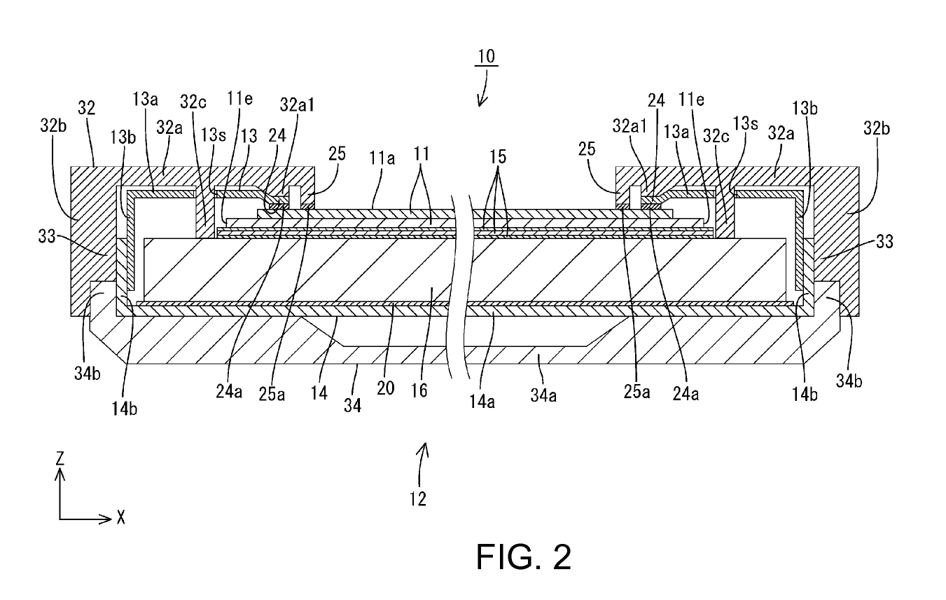

A bezel 13 is arranged inside the front-side cabinet 32 which configures the exterior appearance of the front side of the liquid crystal display device 10. On the other hand, a chassis 14 is arranged inside the rear-side cabinet 34 which configures the exterior appearance of the rear side of the liquid crystal display device 10. As shown in FIG. 2, in the liquid crystal display device 10, the main components are stored in a space provided between the bezel 13 and the chassis 14. The main components stored inside the bezel 13 and the chassis 14 include at least a liquid crystal panel 11, an optical member 15, a light guide plate 16, and an LED unit (not shown). Among them, in a state in which the liquid crystal panel 11, the optical member 15, and the light guide plate 16 are mutually laminated, these components are held and sandwiched between the front side of the bezel 13 and the rear side of the chassis 14. The backlight device 12 is configured by the optical member 15, the light guide plate 16, the LED unit, and the chassis 14, and has a configuration excluding the liquid crystal panel 11 and the bezel 13 from the aforementioned liquid crystal display device. The LED unit configuring the backlight device 12 faces the side end surface of the light guide plate 16 inside the bezel 13 and the chassis 14. The LED unit is configured by an LED substrate (not shown) and an LED as a light source. This LED is the top surface emission type, and a plurality of LEDs is mounted on the LED substrate in a direction of the side end surface side of the light guide plate 16. With this, the light emitted from the LEDs configuring the LED unit is incident on the side end surface (light incident surface) of the light guide plate 16 and is guided inside the light guide plate 16, and the light is emitted from the front surface (light-emitting surface) of the light guide plate 16 and is directed to the display surface 11a side of the liquid crystal panel 11. Hereinafter, each of the components will be described.

The liquid crystal panel 11 is a horizontally elongated shape (rectangular shape) in a plan view, and a pair of glass substrates, which have excellent translucency, are bonded with a predetermined gap, and the liquid crystals are sealed between the substrates. The front side (front surface side) of the pair of the substrates is defined as a CF substrate, and the rear side (rear surface side) is defined as an array substrate. Among them, the array substrate includes switching elements (e.g., TFTs) connecting with source wiring lines and gate wiring lines which are orthogonal to each other, pixel electrodes connecting with the switching elements, an alignment film, and the like. On the other hand, the CF substrate includes a color film in which each of colored parts such as R (red), G (green), B (blue), and the like are arranged in a predetermined arrangement, an opposite electrode, an alignment film, and the like. Polarizing plates (not shown) are respectively arranged on the outside of both of the substrates.

The array substrate among the pair of glass substrates configuring the liquid crystal panel 11 is formed to be slightly larger size than the CF substrate so as to protrude farther than the outer peripheral end part of the CF substrate along the entire periphery. On one side of the long side edge parts of the array substrate, a plurality of terminal parts from the aforementioned gate wiring lines and source wiring lines are provided, and in each of the terminal parts, a flexible substrate in which a driver for liquid crystal driver is mounted is connected thereto. A signal from the aforementioned control substrate CTB is supplied to each terminal part through the flexible substrate, and therefore, an image is displayed on the display surface 11a of the liquid crystal panel 11.

As shown in FIG. 2, the liquid crystal panel 11 is mounted by being stacked on the front side (light emitting side) of the optical member 15 which will be described later, and the rear surface (outer surface of the polarizing plate in the rear side) tightly attaches to the optical member 15 with almost no gap therebetween. Therefore, the entry of the dust or the like between the liquid crystal panel 11 and the optical member 15 is prevented. The display surface 11a of the liquid crystal panel 11 includes a display region capable of displaying an image at the center side of the screen and a non-display region having a frame shape surrounding the display region at the screen peripheral end part side.

As shown in FIG. 2, the optical member 15 has a horizontally elongated shape in a plan view in the same manner as the liquid crystal panel 11, and is slightly larger in size than the liquid crystal panel 11 in a plan view (short side dimension and long side dimension). The optical member 15 is mounted in the laminating manner on the front side (light emitting side) of the light guide plate 16 which will be described later, and is disposed between the aforementioned liquid crystal panel 11 and the light guide plate 16. The optical member 15 includes three sheets stacked on top of each other. A specific type of the optical members 15 includes, for example, a diffusion sheet, a lens sheet, a reflection-type polarizing sheet, and the like, and among them, an appropriate sheet can be selectively used.

The light guide plate 16 is made of a synthetic resin material (e.g., acrylic resin such as PMMA or polycarbonate, or the like) having a sufficiently higher refractive index than air and being approximately transparent (excellent translucency). The light guide plate 16 has a horizontally elongated shape in a plan view in the same manner as the liquid crystal panel 11 and the optical member 15, and the long side direction of the plate surface corresponds to the X-axis direction and the short side direction corresponds to the Y-axis direction, and the plate thickness direction, which is orthogonal to the plate surface, corresponds to the Z-axis direction (direction overlapping the liquid crystal panel 11 and the light guide plate 16). The light guide plate 16 is laminated on the rear side of the optical member 15 and is disposed between the optical member 15 and the chassis 14. As described above, the light guide plate 16 has a function to emit the light upwardly in the direction of the optical member 15 side (front side) while diffusing the LED light, which is guided from the end surface, in the inner part.

On the rear side of the light guide plate 16, that is, the opposite side of the light-emitting surface, as shown in FIG. 2, a reflective sheet 20 capable of upwardly directing the light emitted from the plate surface to the outside of the rear side is provided to cover almost the entire region. In other words, the reflective sheet 20 is disposed between the chassis 14 and the light guide plate 16. The reflective sheet 20 is made of a synthesis resin, and the front surface has white color with excellent light reflectivity. On at least one of the light-emitting surface and the plate surface which is the opposite side to the light-emitting surface of the light guide plate 16, reflective parts (not shown) for reflecting light inside or a scattering parts (not shown) for scattering light inside are patterned to provide a predetermined distribution of light in a plane, and accordingly, the light emitted from the light-emitting surface of the light guide plate 16 is controlled to have a uniform planar distribution.

Next, the configuration of the bezel 13 and the chassis 14 will be described. The bezel 13 and the chassis 14 are made of a metal such as, for example, aluminum, or the like, and the mechanical strength (rigidity) and the heat conductivity are respectively high compared with the case in which these members are made of a synthetic resin. The thermal expansion coefficient and contraction percentage when the expanded state at the time of high temperature shifts to the low-temperature state are reduced. The bezel 13 and the chassis 14 hold and sandwich the liquid crystal panel 11, the optical member 15, and the light guide plate 16, which are laminated on each other, from the front side and the back side while storing the LED unit.

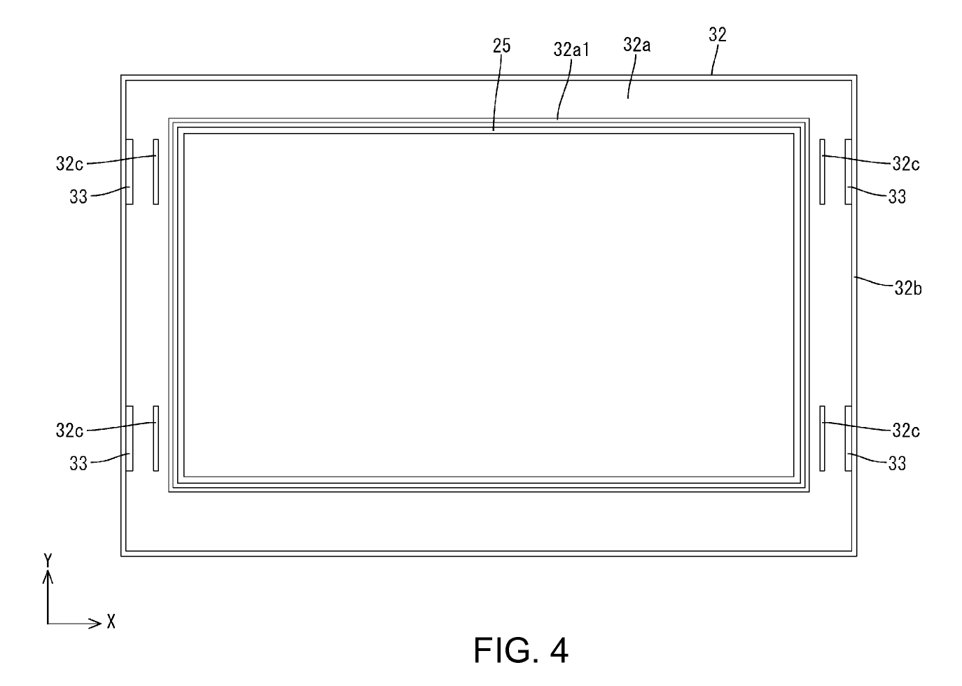

As shown in FIG. 4, the bezel 13 has a horizontally elongated frame shape as a whole in a manner surrounding the display region in the display surface 11a of the liquid crystal panel 11. The bezel 13 is provided with a bezel frame-shaped part 13a having a frame-shaped plate surface along (parallel to) the display surface 11a of the liquid crystal panel 11 and a bezel tube-shaped part 13b cylindrically extending in a direction from the outer end of the bezel frame-shaped part 13a to the rear side (chassis 14 side) along the vertical direction (Z-axis direction), and the cross-section is an approximately L shape. In the inner end of the bezel frame-shaped part 13a, a first panel holding part 24 holding the liquid crystal panel 11 from the front side is provided. In the substantially center position of the outer end and the inner end in the bezel frame-shaped part 13a, a positioning member through hole 13s in which a positioning section 32c of the front-side cabinet 32 described later is inserted is formed with an opening. The bezel frame-shaped part 13b surrounds the liquid crystal panel 11, the optical member 15, the light guide plate 16, and the LED unit (not shown) along the entire periphery. A first cushioning material 24a is provided between the first panel holding part 24 and the liquid crystal panel 11 to cushion the liquid crystal panel 11.

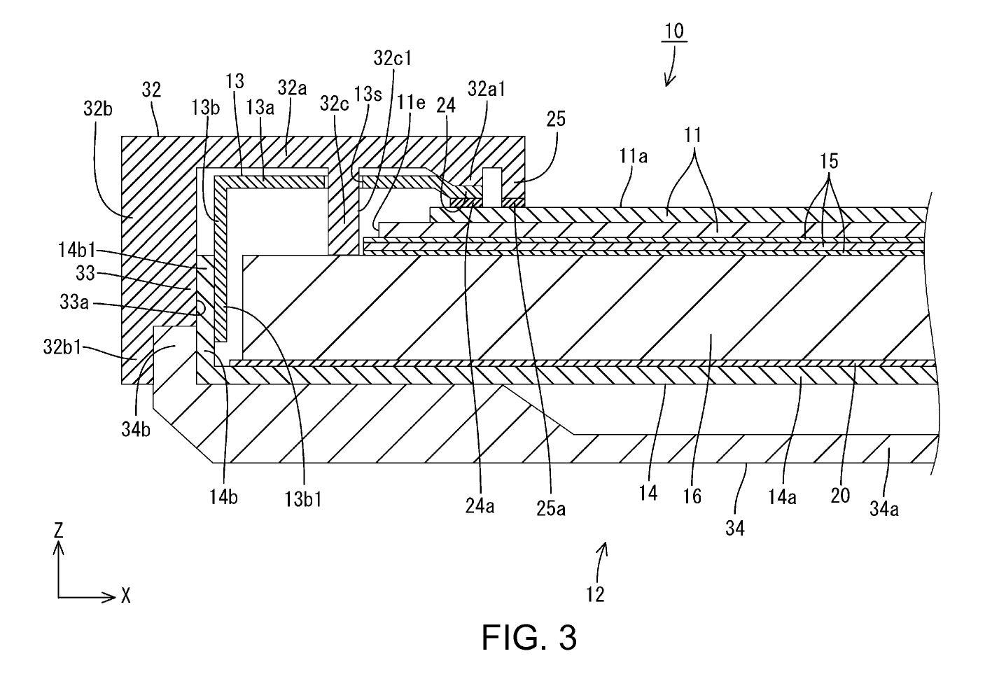

The chassis 14 has a substantially box-shape which entirely opens toward the front side. The chassis 14 is configured by a chassis plate part (an example of plate-shaped part) 14a having a horizontally elongated shape and a plate surface along (parallel to) the display surface 11a of the liquid crystal panel 11, and a chassis side-plate (an example of a side-plate) 14b formed upwardly in a direction of the liquid crystal panel 11 side along the vertical direction (Z-axis direction) from the outer end of the chassis plate part 14a. The chassis plate part 14a supports the light guide plate 16 from the rear side. In the side-plate 14b, the inner surface of the top end part 14b1 (see FIG. 3) contacts with the outer surface of the bezel tube-shaped part 13b of the bezel 13.

Next, the configuration of the front-side cabinet 32 and the rear-side cabinet 34 will be described. The front-side cabinet 32 and the rear-side cabinet 34 are made of a synthetic resin. Therefore, the thermal expansion coefficient and the contraction percentage when the expanded state at the time of high temperature shifts to the low-temperature state of the cabinets 32 and 34 are high compared with the case in which the bezel 13 and the chassis 14 are made of a metal. The front-side cabinet 32 is formed relatively adjacent to the outer side with respect to the bezel 13, and the rear-side cabinet 34 is formed relatively adjacent to the outer side with respect to the chassis 14, and therefore, the cabinets 32 and 34 configure the exterior appearance of the liquid crystal display device 10.

As shown in FIG. 2, the entire front-side cabinet 32 has a horizontally elongated frame shape, similar to the bezel 13. The front-side cabinet 32 is provided with an exterior frame shaped part 32a having a frame-shaped plate surface along (parallel to) the display surface 11a of the liquid crystal panel 11, and an exterior tube-shaped part 32b extending in a direction from the outer end of the exterior frame shaped part 32a to the rear side (chassis 14 side) cylindrically along the vertical direction (Z-axis direction), and has an approximately L-shape. In the inner end of the exterior frame shaped part 32a, a second panel holding part 25 holding the liquid crystal panel 11 from the front side is provided. The second panel holding part 25 is arranged in a position adjacent to the inner side with respect to the first panel holding part 24. Further, a second cushioning material 25a cushioning the liquid crystal panel 11 is arranged between the second panel holding part 25 and the liquid crystal panel 11. Further, in the exterior frame shaped part 32a, a support holding member 32a1 supporting the first panel holding part 24 is formed in a manner in which the support holding member 32a1 expands in a direction of the rear side. The first panel holding part 24 and the second panel holding part 25 have a horizontally elongated frame shape, similar to the outer peripheral side part (non-display region, frame part) of the liquid crystal panel 11, and are capable of holding the outer peripheral side part of the liquid crystal panel 11 from the front side along the entire periphery. In the exterior tube-shaped part 32b, the inner surface in the top end part 32b 1 (see FIG. 3) contacts with the outer surface of the cabinet side-plate 34b of the rear-side cabinet 34 which will be described later. In the inner surface side of the exterior tube-shaped part 32b, a contact section 33 integrally formed with the exterior tube-shaped part 32b is provided. The contact section 33 will be described later.

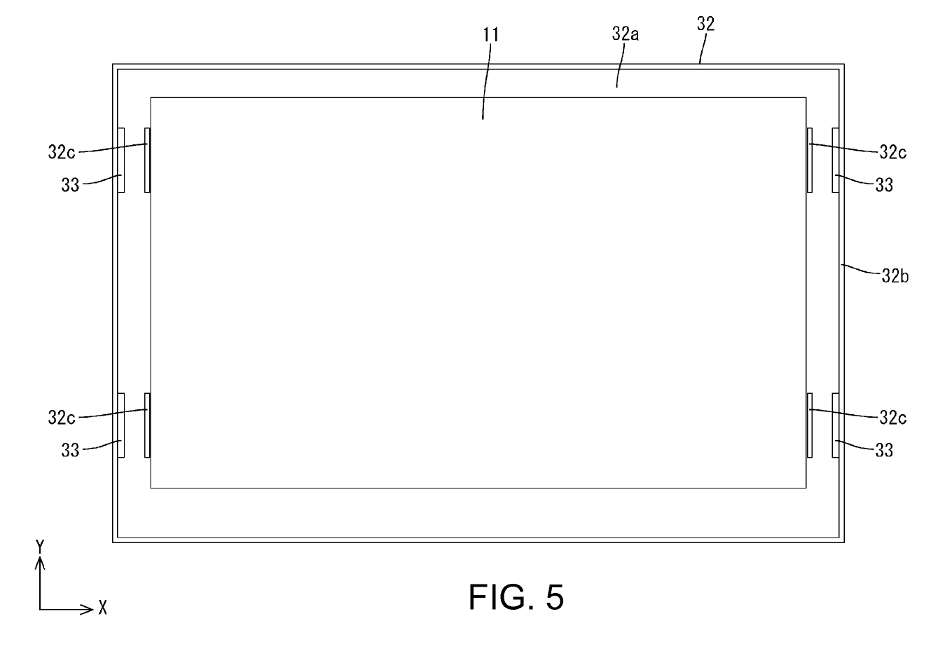

A positioning section 32c integrally formed with the exterior tube-shaped part 32a and protruding in a direction of the rear side (chassis side) in a block shape (rib-shape, prismatic shape) is provided between the support holding member 32a1 and the exterior tube-shaped part 32b of the front-side cabinet 32 as shown in FIG. 2 and FIG. 3. As shown in FIG. 4 and FIG. 5, four positioning sections 32c are provided in total, and two are provided on each short side of the front-side cabinet 32 in the exterior frame shaped part 32a. Each of the positioning sections 32c has an elongated shape along the short side direction (Y-axis direction) of the front side cabinet 32 in a plan view. Each of the positioning sections 32c presses down the light guide plate 16 from the front side (display surface 11a side) by being inserted into the positioning member through hole 13s provided in the bezel frame-shaped part 13a and contacting the top end surface with the front surface (light-emitting surface) of the light guide plate 16, and therefore, the positioning sections have a function of supporting the light guide plate 16.

Further, for each of the positioning sections 32c, the inner surface 32c1 faces the side end surface 11e of the short side of the liquid crystal panel 11 (specifically, the side end surface of the array substrate configuring the liquid crystal panel 11) in parallel and they are closely and adjacently arranged. Here, in the manufacturing processes of the liquid crystal display device 10, the parts are assembled from the front side of the liquid crystal display device 10 in order, and thus the liquid crystal display device 10 is manufactured. Specifically, in a state where the front-side cabinet is upside down, each of the positioning sections 32c is inserted into the positioning member through hole 13s provided in the bezel frame-shaped part 13a and the bezel 13 is assembled, and next, the liquid crystal panel 11 is mounted on the rear side of the bezel 13. At this time, as shown in FIG. 5, the inner surface 32c1 of each of the positioning sections 32c provided in the front-side cabinet 32 and the side end surface 11e of the short side of the liquid crystal panel 11 are closely and adjacently faced in parallel, and the movement of the liquid crystal panel 11 in the direction of the display surface 11a (X-Y planar direction) is regulated by the positioning sections 32c by mounting the liquid crystal panel 11 on the rear side of the bezel 13, and thus the liquid crystal panel 11 can be positioned. That is, each of the positioning sections 32c has a positioning function to position the liquid crystal panel 11 in the manufacturing processes of the liquid crystal display device 10. The optical member 15 is also arranged inside the positioning sections 32c, and thus in the manufacturing processes of the liquid crystal display device 10, the optical member 15 can be also positioned in a similar procedure to the liquid crystal panel 11.

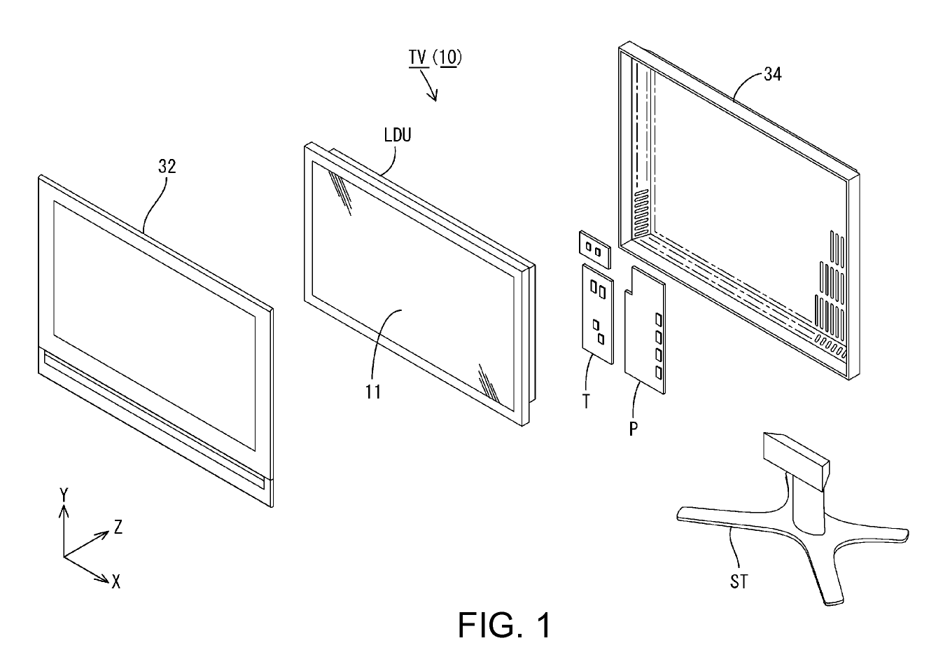

The rear-side cabinet 34 has a substantially box-shape and its entirety opens toward the front side, similar to the chassis 14. The rear-side cabinet 34 is provided with an exterior plate-shaped part 34a having a horizontally elongated shape and the plate surface along (parallel to) the display surface 11a of the liquid crystal panel 11, and a cabinet side-plate 34b formed upwardly in a direction of the liquid crystal panel 11 side along the vertical direction (Z-axis direction) from the outer end of the exterior plate-shaped part 34a. A part of the inner surface of the exterior plate-shaped part 34a contacts with the outer surface of the chassis plate part 14a. Further, the inner surface of the cabinet side-plate 34b contacts with a part of the outer surface of the chassis side-plate 14b. The vicinity of the center of the exterior plate-shaped part 34a has a shape recessed toward the outer side, and therefore, a space is formed between the exterior plate-shaped part 34a and the chassis plate part 14a of the chassis 14. The aforementioned substrates T and P (see FIG. 1) are stored inside this space.

Next, the configuration of the contact section 33, which is the main element of the present embodiment, will be described. The contact section 33 is arranged on the opposite side of the positioning section 32c (that is, the outside) with respect to each of the bezel tube-shaped parts 13b and the chassis side-plates 14b, and is integrally formed with the exterior tube-shaped part 32b in the inner surface side of the exterior tube-shaped part 32b of the front-side cabinet 32 as described above. As shown in FIG. 3, the contact section 33 is entirely provided in the inner surface of the exterior tube-shaped part 32b except the top end part 32b1 of the exterior tube-shaped part 32b, and is protruded in a stepped shape in a direction from the inner surface of the exterior tube-shaped part 32b to the inner side. Therefore, in the exterior tube-shaped part 32b, the thickness (width in the X-axis direction) of the part excluding the top end part 32b1 is greater than the thickness of the top end part 32b1. Further, four contact sections 33 are provided in total, and two are provided on each short side of the front-side cabinet 32 in the exterior tube-shaped part 32b. Specifically, as shown in FIG. 4 and FIG. 5, each contact section 33 overlaps with the positioning section 32c in a direction from the positioning section 32c to the side end surface 11e of the liquid crystal panel 11, that is, the X-axis direction. The contact section 33 is more elongated than each of the positioning sections 32c along the short side direction (Y-axis direction) of the front side cabinet 32 when viewing each of the positioning sections 32c in a plan view.

A part of the inner surface of the contact section 33 is in surface contact with the outer surface in the top end part 14b1 of the chassis side-plate 14b. In other words, it can be said that the contact section 33 contacts with both of the chassis side-plate 14b and the exterior tube-shaped part 32b. Here, the top end part 14b1 of the chassis side-plate 14b contacts with the top end part 13b1 of the bezel tube-shaped part 13b as described above, and thus the contact section 33 and the top end part 14b1 of the chassis side-plate 14b and the top end part 13b1 of the bezel tube-shaped part 13b are overlapped in a direction from the positioning section 32c to the side end surface 11e of the liquid crystal panel 11, that is, the X-axis direction. The contact section 33 and the bezel tube-shaped part 13b are separated by the thickness of the chassis side-plate 14b.

In the liquid crystal display device 10 of the present embodiment, when the high-temperature state at the time of turning on the LED (state in which the front-side cabinet 32 is expanded by heat) shifts to the low-temperature state at the time of turning off the LED, the front-side cabinet 32 made of a synthetic resin contracts towards the center of the liquid crystal panel 11 as a whole. Here, if the aforementioned contact sections 33 are not arranged on the inner side of the exterior frame shaped part 32a configuring the front-side cabinet 32, the positioning sections 32c provided on the exterior frame shaped part 32a configuring the front-side cabinet 32 are moved to the inner side by the front-side cabinet 32 contracting as a whole, and the inner surface 32c1 of the positioning sections 32c contacts with the side end surface 11e of the liquid crystal panel 11. When the front side cabinet 32 further contracts, the contacting part with the side end surface 11e of the liquid crystal panel 11 is pressed towards the center of the liquid crystal panel 11 by the positioning sections 32c. As a countermeasure, in the liquid crystal display device 10 of the present embodiment, the contact sections 33 are arranged, and thus when the front-side cabinet 32 contracts towards the center of the liquid crystal panel 11, a pressing force is applied in a direction from the contact sections 33 to the chassis side-plate 14b which contacts with the contact sections 33 at the same time of the contraction of the front-side cabinet 32, that is, in the direction of the contraction of the front-side cabinet 32. Here, the bezel tube-shaped part 13b and the chassis side-plate 14b are made of a metal, and on the other hand, the front-side cabinet 32 is made of a synthetic resin, and thus the contraction percentage of the bezel tube-shaped part 13b and the chassis side-plate 14b when the expanded state at the time of the high-temperature shifts to the low-temperature state is reduced compared with the front-side cabinet 32. Therefore, even though the pressing force is applied in a direction from the exterior tube-shaped part 32b of the front-side cabinet 32 to at least one of the bezel tube-shaped part 13b and the side-plate 14b via the contact section 22, the adverse pressing force is applied to the contact sections 33 from the chassis side-plate 14b which contacts with the contact sections 33. As a result, the pressing force is applied to the exterior tube-shaped part 32b of the front-side cabinet 32 in a direction (outside direction) which is opposite from the direction (inside direction) of the contraction of the front-side cabinet 32 via the contact sections 33.

Here, the direction of the pressing force applied to at least one of the bezel tube-shaped part 13b and the side-plate 14b is equal to the direction in which the front-side cabinet 32 contracts, and thus the contraction of the front-side cabinet 32 is prevented and suppressed by applying the pressing force to the exterior tube-shaped part 32b in the direction which is opposite from the direction of the contraction of the front-side cabinet 32. As a result, this prevents the positioning sections 32c from contacting with the side end surface 11e of the liquid crystal panel 11, or, even if the positioning sections 32c contact with the side end surface 11e of the liquid crystal panel 11, the pressure applied in a direction from the positioning sections 32c of the front-side cabinet 32 to the side end surface 11e side of the liquid crystal panel 11 is reduced. Therefore, in the liquid crystal display device 10 of the present embodiment, due to the pressing force being applied to the parts facing the positioning sections 32c in the side end surface 11e of the liquid crystal panel 11 towards the center of the liquid crystal panel 11 by the positioning sections 32c, the phenomenon such as a part of the display surface 11c of the liquid crystal panel 11 being displayed in white can be prevented and suppressed.

Further, in the present embodiment, the contact sections 33 are formed in the part of the front-side cabinet 32. With such a configuration, the contact sections 33 are integrally formed with the front-side cabinet 32, and thus the assembly of the contact sections 33 can be simplified in the manufacturing processes of the liquid crystal display device 10, and the manufacturing processes can be shortened.

Further, in the present embodiment, four contact sections 33 are arranged inside the exterior tube-shaped part 32b. With such a configuration, at the time of the contraction of the front-side cabinet 32, the contraction force of the front-side cabinet 32 towards the center of the liquid crystal panel 11 is effectively reduced by the four contact sections 33. Therefore, at the time of the contraction of the front-side cabinet 32, the pressing force applied to the parts of the side end surface 11e of the liquid crystal panel 11, which contacts with the positioning sections 32c, in the direction of the center side of the liquid crystal panel 11 can be further prevented and suppressed by the positioning sections 32c.

Further, in the present embodiment, each contact section 33 is overlapped with the positioning section 32c in a direction (X-axis direction) from the positioning section 32c to the side end surface 11e of the liquid crystal panel 11. With such a configuration, the contact section 33 and the positioning section 32c are closely and adjacently formed, and thus at the time of the contraction of the front-side cabinet 32, the pressing force applied to the parts of the liquid crystal panel 11, which contact with the positioning sections 32c, in the direction towards the center of the liquid crystal panel 11 by the positioning sections 32c can be effectively prevented and suppressed by the contact sections 33.

Further, in the present embodiment, the parts contacting with the chassis side-plate 14b in the contact sections 33 are overlapped with the bezel tube-shaped part 13b in the direction (X-axis direction) from the positioning section 32c to the side end surface 11e of the liquid crystal panel 11. With such a configuration, at the time of the contraction of the front-side cabinet 32, the pressing force is applied to the contact sections 33 from the bezel tube-shaped part 14b and the chassis side-plate 14b, and thus the contraction force of the front-side cabinet 32 towards the center of the liquid crystal panel 11 can be effectively prevented and suppressed.

Further, in the present embodiment, the contact sections 33 are in surface contact with the chassis side-plates 14b. With such a configuration, the contact area of the part where the contact sections 33 contact with the chassis side-plates 14b can be greater than the case in which the contact sections 33 are in point contact with the chassis side-plates 14b, and thus at the time of the contraction of the front-side cabinet 32, the pressing force is effectively applied to the contact sections 33 from the chassis side-plates 14b. Therefore, the contraction force of the front-side cabinet 32 towards the center of the liquid crystal panel 11 can be effectively prevented and suppressed.

### Embodiment 2

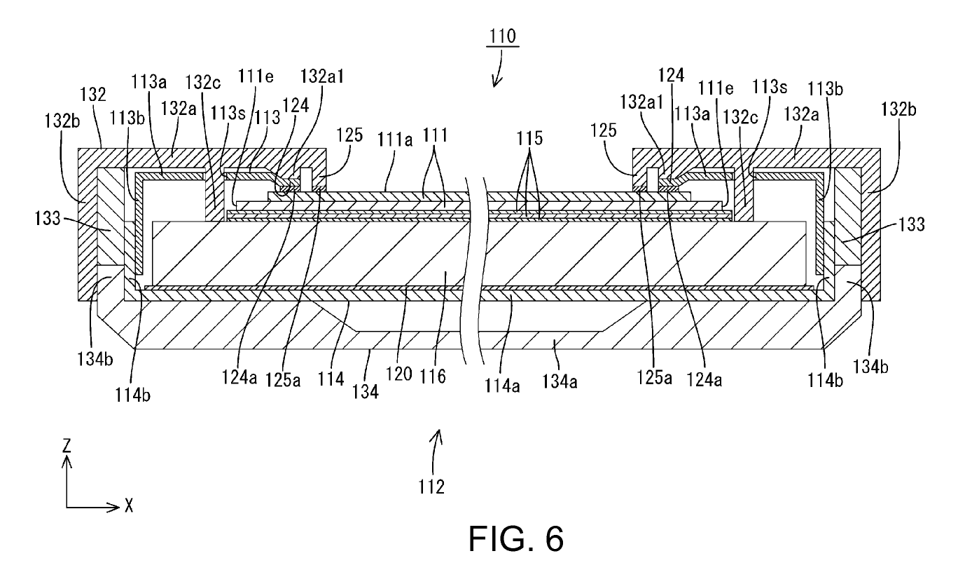

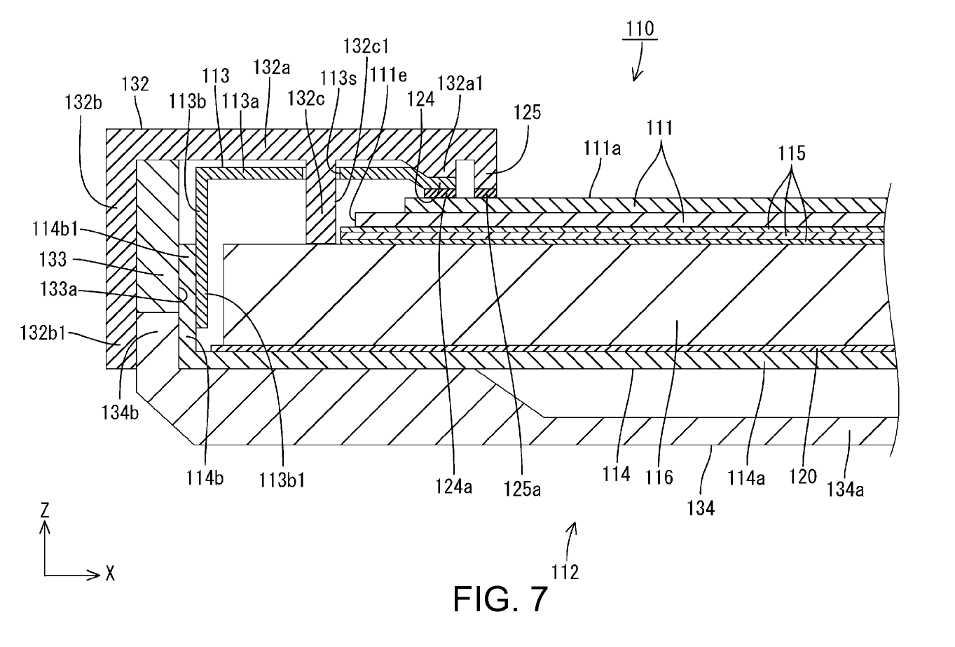

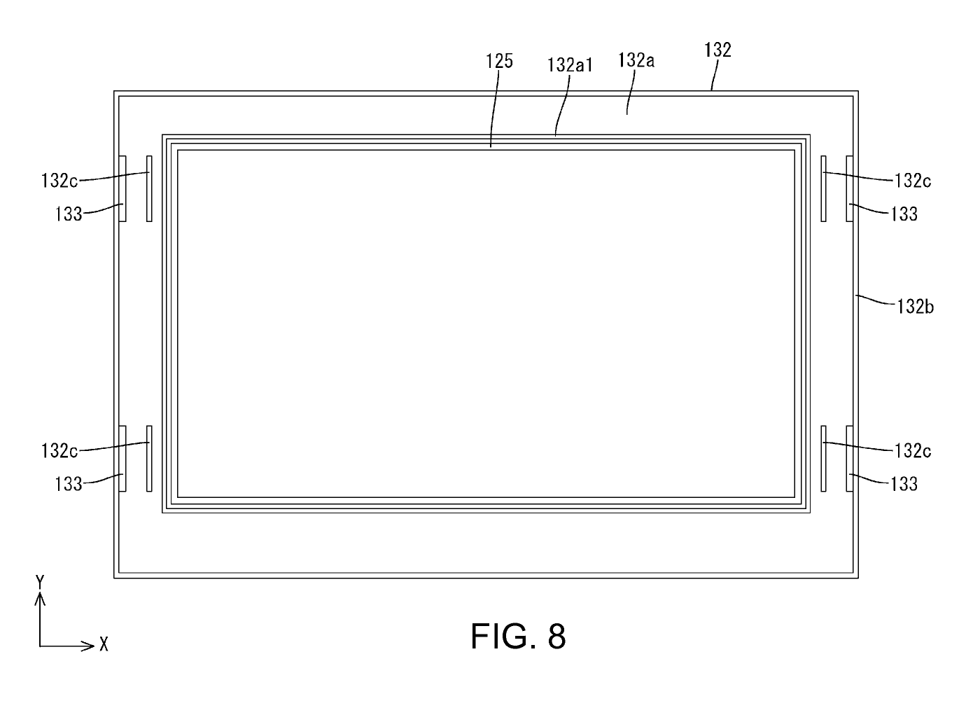

Embodiment 2 will be described in reference to the drawings. In Embodiment 2, the configuration of the contact sections 133 is different from Embodiment 1. Other configurations are the same as Embodiment 1, and thus the descriptions of the configurations, the functions, and the effects are omitted. In FIG. 6, FIG. 7, and FIG. 8, parts having reference characters in each of FIG. 2, FIG. 3, and FIG. 4 with 100 added are the same as the parts described in Embodiment 1.

In the liquid crystal display device 110 according to Embodiment 2, as shown in FIG. 6 and FIG. 7, the contact sections 133 are not integrally formed with the exterior tube-shaped part 132b of the front-side cabinet 132, but instead are a separate members. The contact sections 133 in the present embodiment have the same shape and arrangement (see FIG. 8) as the contact sections 33 in Embodiment 1. Accordingly, the contact sections 133 are arranged on the opposite side of the positioning sections 132c with respect to each of the bezel tube-shaped parts 113b and the chassis side-plates 114b, and contact with both of the chassis side-plates 114b and the exterior tube-shaped part 132b. In the present embodiment, the contact sections 133 having such a configuration allows the contact sections 133 to be shifted even after completing the assembly of the liquid crystal display device 110, and the position of the contact sections 133 can be adjusted.

Further, in the present embodiment, the contact sections 133 are made of a material (e.g., metals) which is harder than the front-side cabinet 132. Here, when the contact sections 133 are made of a material which is softer than the front-side cabinet 132, the contact sections 133 contract by the exterior tube-shaped part 132b due to the contraction of the front-side cabinet 132, and when the front-side cabinet 132 contracts, the pressure may be hardly applied in a direction from the exterior tube-shaped part 132b to the chassis side-plates 114b through the contact sections 133. In this point, according to the present embodiment, when the front-side cabinet 132 contracts, the contact sections 133 hardly contract by the exterior tube-shaped part 132b, and thus when the front-side cabinet 132 contracts, the pressure can be easily applied in a direction from the exterior tube-shaped part 132b to the chassis side-plates 114b through the contact sections 133. As a result, the contraction of the front-side cabinet 132 can be effectively prevented and suppressed.

### Modification Example of Embodiment 2

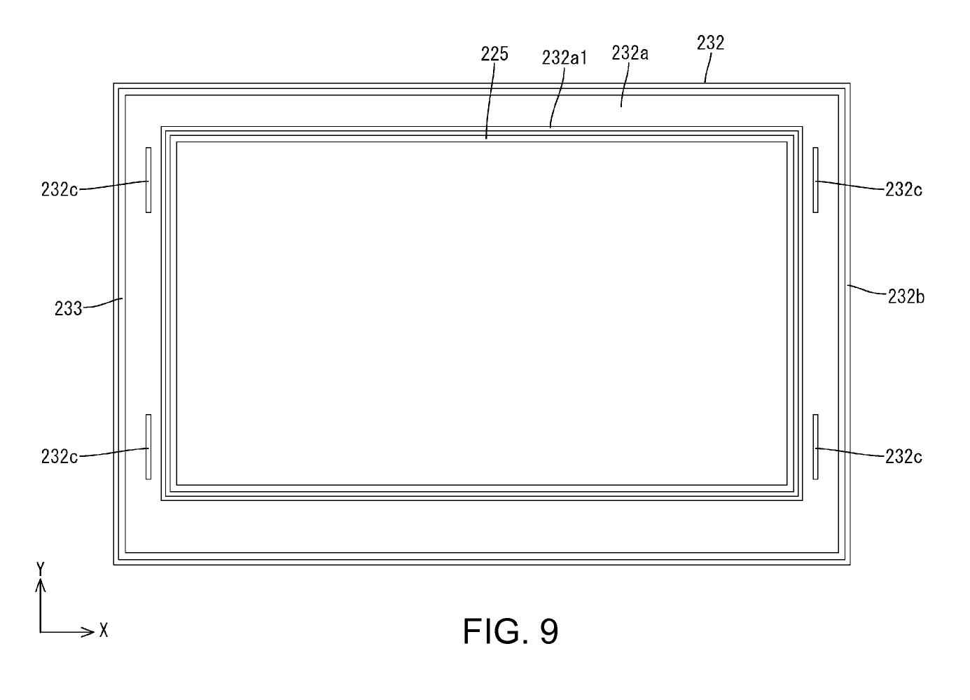

Next, a modification example of Embodiment 2 will be described. In FIG. 9, parts having reference characters in FIG. 4 with 200 added are the same as the parts described in Embodiment 1 and Embodiment 2. In the modification example of Embodiment 2, as shown in FIG. 9, the contact sections 233, which are separate members from the exterior tube-shaped part 232b, have a frame shape and are formed along the inner periphery of the exterior tube-shaped part 232b. With such a configuration, the contact sections 233 contact the entire outer periphery of the chassis side-plate, and thus at the time of the contraction of the front-side cabinet 232, the contraction force of the front-side cabinet 232 towards the center of the liquid crystal panel is effectively reduced by the contact sections 233. Therefore, at the time of the contraction of the front-side cabinet 232, the pressing force applied to the parts of the liquid crystal panel, which contact with the positioning sections 232c, in the direction of the center side of the liquid crystal panel by the positioning sections 232c can be further prevented and suppressed.

### Embodiment 3

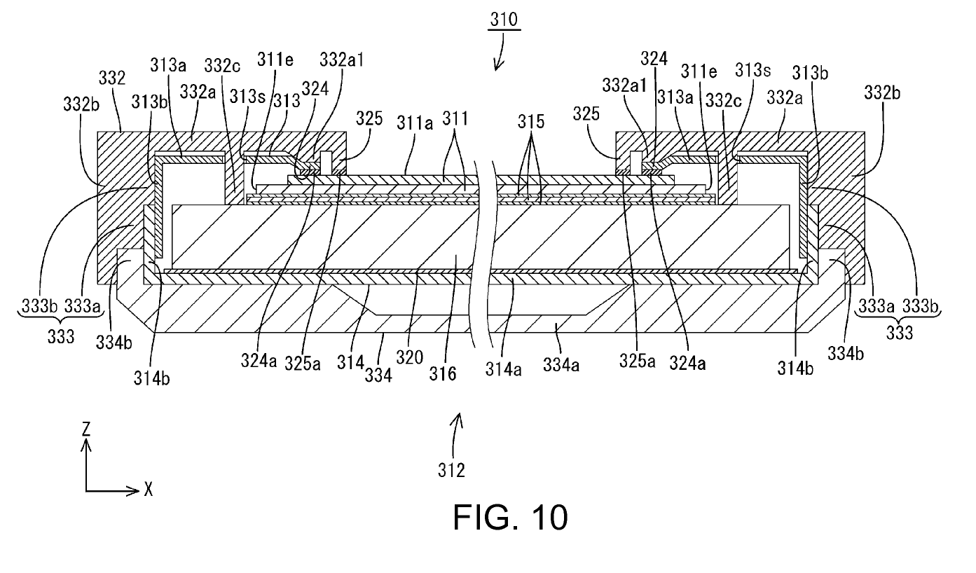

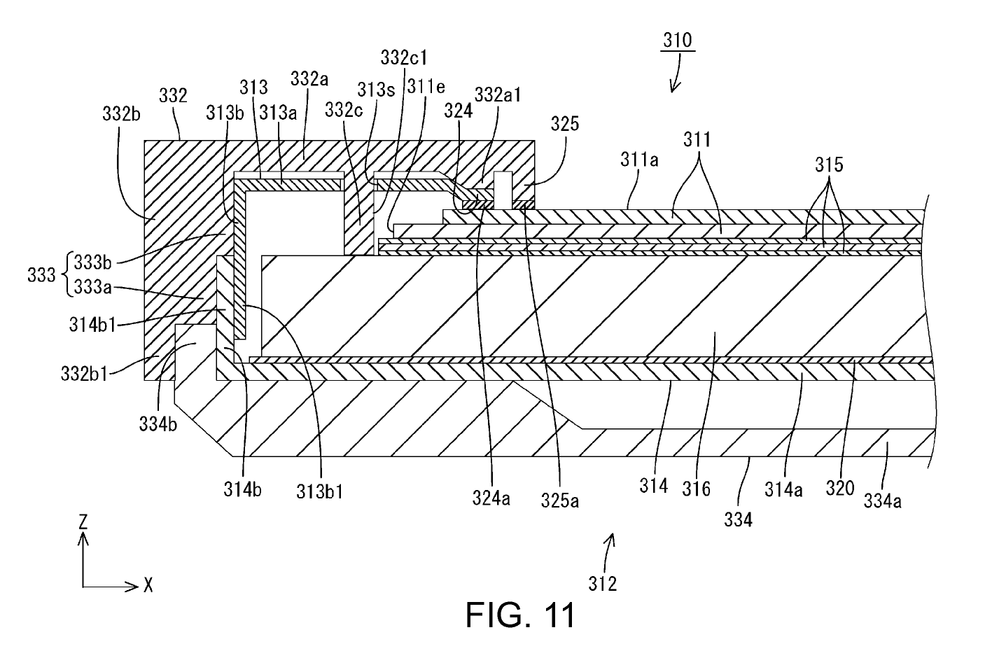

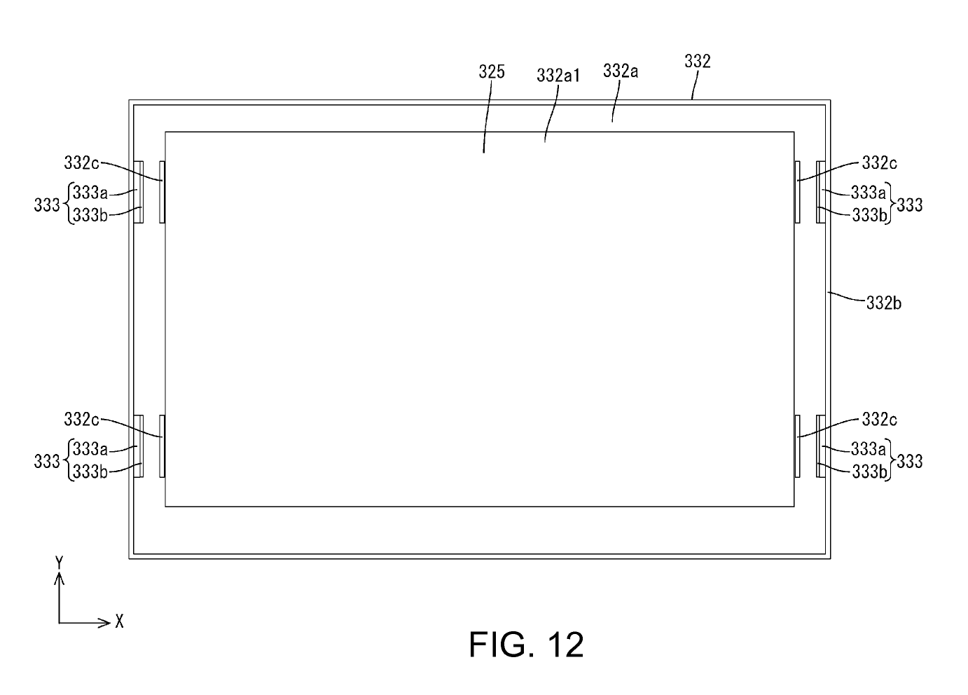

Embodiment 3 will be described in reference to the drawings. A shape of the contact sections in Embodiment 3 is different from Embodiment 1. Other configurations are the same as Embodiment 1, and thus the descriptions of the configurations, the functions, and the effects are omitted. In FIG. 10, FIG. 11, and FIG. 12, parts having reference characters in each of FIG. 2, FIG. 3, and FIG. 4 with 300 added are the same as the parts described in Embodiment 1.

As shown in FIG. 10 and FIG. 11, in the liquid crystal display device 310 according to Embodiment 3, the contact sections 333 are provided with the first contact section 333a which contacts with the outer surface in the top end part 314b1 of the chassis side-plate 314b by protruding to the inner side from the exterior tube-shaped part 332b, and the second contact section 333b which contacts with the outer surface of the bezel tube-shaped part 313b by further protruding to the inner side farther than the first contact section 333a in a stepwise manner. Accordingly, the first contact section 333a has the same shape as the contact section 33 in Embodiment 1, and the first contact section 333a and the second contact section 333b configuring the contact section 333 are formed in a stepwise manner in the cross-sectional view shown in FIG. 10 and FIG. 11. A shown in FIG. 12, the shape of the second contact sections 333b in a plan view is the same shape as the first contact sections 333a in a plan view (shape of the contact sections 33 in Embodiment 1 in a plan view). Therefore, in the present embodiment, the contact sections 333 are not separated from the bezel tube-shaped part 313b, which is different from Embodiment 1, and the contact sections 333 contact with the chassis side-plate 314b and the bezel tube-shaped part 313b. In the present embodiment, with such a shape of the contact sections 333, at the time of the contraction of the front-side cabinet 332, the pressing force is applied to the contact sections 333 from the bezel tube-shaped part 313b and the side-plate 314b, and thus the contraction force of the front-side cabinet 332 in the direction of the center side of the liquid crystal panel 311 can be effectively prevented and suppressed.

Modification examples in each of the aforementioned embodiments will be described.

(1) In each of the aforementioned embodiments, the configuration in which the contact sections contact with at least the outer surface of the chassis side-plate was exemplified, but it may contact only the outer surface of the bezel tube-shaped part.

(2) In each of the aforementioned embodiments, the configuration in which the exterior member configuring the exterior appearance of the liquid crystal display device is provided with the front-side cabinet and the rear-side cabinet, but the configuration of the exterior member is not limited as long as the member provided with the positioning sections and the member contacted with the contact sections are the same member. For example, the exterior member may be configured by one member, and the exterior member may be configured by more than three members.

(3) In each of the aforementioned embodiments, a configuration is described in which the positioning sections are provided in four points in the short side of the front-side cabinet, but the configuration or the shape is not limited as long as the positioning sections are protruded from the exterior frame shaped part and are closely and adjacently formed to face the side end surface of the liquid crystal panel. For example, the positioning sections may be provided with a frame shape to face the entire side end surface of the liquid crystal panel.

(4) In each of the aforementioned embodiments, the liquid crystal display device provided with the edge-lit type backlight device having the light guide plate was exemplified, but it may be the liquid crystal display device provided with the direct-lit type backlight device.

(5) In each of the aforementioned embodiments, the configuration, the shape, the arrangement, and the like of the contact section may be altered if necessary.

(6) In each of the aforementioned embodiments, the configuration, the shape, the arrangement, and the like of the positioning section may be altered if necessary.

(7) In each of the aforementioned embodiments, the configuration, the shape, and the like of the exterior member may be altered if necessary.

(8) In each of the aforementioned embodiments, the liquid crystal display device in which the liquid crystal panel is used as a display panel was exemplified, but the present invention is applicable to a display device in which a different type of a display panel is used.

(9) In each of the aforementioned embodiments, the television receiver device provided with the tuner was exemplified, but the present invention is applicable to the display device which is not provided with the tuner.

Each embodiment of the present invention has been described in detail. The embodiments are for illustrative purposes only and by no means limit the scope of the present invention. Technologies described in the present invention include variations and modifications of the embodiments and examples described above.

Further, the technical elements described or shown in the specification or drawings exhibit technical usefulness individually or in various combinations thereof. The technical elements are not limited to the combinations defined in the claims at the time of filing the application. Furthermore, the technologies illustrated in the specification or drawings achieve a plurality of purposes at the same time and have a technical usefulness when one of the purposes is achieved.

### DESCRIPTION OF REFERENCE CHARACTERS

TV television receiver device
LDU liquid crystal display unit
P power source
T tuner
ST stand
10, 110, 310 liquid crystal display device
11, 111, 311 liquid crystal panel
12, 112, 312 backlight device
13, 113, 313 bezel
13a, 113a, 313a bezel frame-shaped part
13b, 113b, 313b bezel tube-shaped part
14, 114, 314 chassis
14a, 114a, 314a chassis plate part
14b, 114b, 314b chassis side-plate
15, 115, 315 optical member
16, 116, 316 light guide plate
20, 120, 320 reflective sheet
32, 132, 232, 332 front-side cabinet
32a, 132a, 232a, 332a exterior frame shaped part
32b, 132b, 232b, 332b exterior tube-shaped part
33, 133, 233, 333 contact section
34, 134, 334 rear-side cabinet
34a, 134a, 334a exterior plate-shaped part
34b, 134b, 334b cabinet side-plate

1. A display device, comprising:
an illumination device;
a display panel that performs display with light from the illumination device;
a chassis made of metal and arranged opposite to a display surface side of the display panel, said chassis comprising a plate that has a surface parallel to said display surface of the display panel and a side-plate rising upwardly towards the display panel from an end of the plate of the chassis;
a bezel made of metal and housing at least the illumination device and the display panel between the bezel and the chassis, said bezel comprising a bezel frame part provided along edges of the display surface of the display panel and a bezel side-plate extending downward from edges of the bezel frame part of the bezel towards the chassis;
an exterior member made of resin and forming an exterior of the display device, said exterior member covering at least the bezel and comprising an exterior frame part provided along said edges of the display surface of the display panel and an exterior side-plate extending downward from edges of the exterior frame part towards the chassis;
a positioning section that protrudes downward from the exterior frame part of the exterior member toward the chassis, the positioning section being located on an inner side of the display panel in a plan view relative to the bezel side-plate and the exterior side-plate so that a portion of said positioning section faces an end face of the display panel, thereby regulating a horizontal position of the display panel; and
a contact section provided on the exterior side-plate of the exterior member, said contact section on the exterior side-plate being in contact with at least one of the bezel side-plate of the bezel and the side-plate of the chassis.

2. The display device according to claim 1, wherein the bezel frame part has a positioning through-hole in which the positioning section is inserted.

3. The display device according to claim 1, wherein the contact section is separate from the exterior member.

4. The display device according to claim 3, wherein the contact section is made of a material that is harder than the exterior member.

5. The display device according to claim 1, wherein the contact section is part of the exterior member.

6. The display device according to claim 1, wherein the contact section is provided in a plurality.

7. The display device according to claim 1, wherein the contact section has a frame shape along an inner periphery of the exterior tube shaped part side-plate.

8. The display device according to claim 1, wherein the contact section and the positioning section are positioned such that in a side view of the display device, as seen from one side of the display device, the contact section overlaps the positioning section.

9. The display device according to claim 1, wherein a portion of the contact section contacting one of the bezel side-plate and the side-plate of the chassis overlaps the other of the bezel side-plate and the side-plate of the chassis in a side view, as seen from one side of the display device.

10. The display device according to claim 1, wherein the contact section contacts both the bezel side-plate and the side-plate of the chassis.

11. The display device according to claim 1, wherein the contact section is in surface-to-surface contact with at least one of the bezel side-plate and the side-plate of the chassis.

12. The display device according to claim 1, wherein the exterior member comprises a first exterior member that has the exterior frame part and the exterior side-plate and that covers the bezel from a side opposite to the display panel, and a second exterior member that has an exterior plate covering the plate of the chassis from the side opposite to the display panel and an exterior side-plate that rises towards the display panel from an outer end of the exterior plate, said exterior member covering the entire display device except for the display surface of the display panel.

13. The display device according to claim 1, wherein the display panel is a liquid crystal panel having liquid crystal.

14. A television receiver, comprising: the display device according to claim 1.
